(19) United States
(12) Patent Application Publication
(10) Pub. No.: US 2015/0375933 A1
(43) Pub. Date: Dec. 31, 2015

(54) Carrier for animal waste

(71) Applicant: Nancy First, Jericho, NY (US)

(72) Inventor: Nancy First, Jericho, NY (US)

(73) Assignee: CaliBlue LLC

(21) Appl. No.: 14/545,562

(22) Filed: May 21, 2015

Related U.S. Application Data
(60) Provisional application No. 61/997,083, filed on May 21, 2014.

(51) Int. Cl. B65F 1/00; A45F 3/00

(52) U.S. Cl. CPC B65F 1/0006; A45F 3/00

(57) ABSTRACT

A carrier for animal waste where an animal is being walked by their owner.

### RELATED APPLICATIONS

The present application claims priority to provisional patent application no. 61/997,083 filed May 21, 2014.

### FIELD OF THE INVENTION

The present invention relates to a carrier for animal waste where an animal is being walked by their owner.

### BACKGROUND OF THE INVENTION

U.S. Pat. No. D668,009 relates to a dog waste bag.

U.S. Pat. No. 6,073,590 relates to a dog leash equipped with a container for containing a supply of plastic grocery bags, for collecting pet excrement. The container is stitched to the leash. The container is of light-weight fabric or material, and takes its structure from being stitched to the leash, lengthwise along the container. The open mouth of the container is wrapped around the leash and secured with Velcro.

U.S. Pat. No. 6,418,881 relates to a leash pouch for storing disposable bags and for temporarily storing animal waste comprising a first pocket having an opening, a second pocket having an opening, the second pocket having a device for partially restricting its opening whereby at least one disposable plastic bag can be stored in the second pocket. The first pocket adapted to temporarily store a plastic bag having waste. The pouch has an upper fastener device for detachable securement to a handle portion of a leash and has a lower device for slidable connection with a linear portion of the leash.

U.S. Pat. No. 7,506,615 relates to an animal waste collection and disposal system having a portable carrying housing with a plurality of separately sealable compartments, an integral ergonomic handle and integral apparatus to mount a leash. The collection and disposal system includes an animal waste collection tongs device having a protective shield, and a waste disposal device having a biodegradable bag and a catalyst pouch integral to the bag.

U.S. Pat. No. 8,113,481 relates to a method and device for carrying animal waste bags made from a unitary body comprising a hook for transporting the device and apertures to seal and hold the bags. The bags are inserted into an aperture and drawn through a compression slot which temporarily seals the bags. The device can then be attached to a variety of objects utilizing the integrated hook for hands free transportation of the waste bags.

US patent publication 2013/0125834 relates to a dog walking tube comprising a hollow tube having a first end and a second end. The hollow tube has a portion that holds fecal matter waste bags. The opposite or second end of the hollow container receives and stores fecal matter waste bags.

US patent publication 2008/0163822 relates to a pet waste and other item storage case secured to the pet for carrying. In addition to a waste compartment, other pockets may be included to carry other items including pet items, food, water, toys, extra baggies) or owner's items (cell phone, keys, etc.).

US patent publication 2008/0048463 relates to a bag scoop device to collect dog waste. The invention includes a bag that contains the scoop and attached frame. The frame is placed in the opening of the bag as the scoop is removed.

US patent publication 2009/0039129 relates to a storage pouch article for use in handling dog waste whereby the bag holds used waste collection bags and a roll of waste collection plastic bags, whereby the plastic bags may be dispensed while the pouch is in a rolled position.

US patent publication 2011/0185984 relates to an apparatus and methods for the containment of animal waste. Some embodiments relate to pet waste containment apparatus. Other embodiments relate to apparatus for intercepting animal waste.

US patent publication 2011/0290188 relates to a leash assembly that includes a housing comprising a handle. The housing includes a dispensing opening and a retention opening. The dispensing opening provides access to an unused pet waste bag contained within the housing, and the retention opening retains a used pet waste bag. A method of disposing of pet waste includes walking a dog utilizing a leash assembly; causing pet waste to be contained within a pet waste bag, transitioning the pet waste bag from an unused state to a used state; closing the pet waste bag by tying a knot; and retaining the pet waste bag via engagement of the knot with a retention opening of the leash assembly.

US patent publication 2013/0082470 relates to an all in one hygienic, pet secure (no contact with pet waste), pet waste catch, carry and dispose tool kit, including compact size, usable with any kind of plastic bag, attaches to a belt, clothing, etc.

US patent publication 2012/0193386 relates to a unisex bag that temporarily holds dog-waste in a secure sanitary place, providing a dispenser compartment for disposable waste bags, it has extra outer storage for accessories such as gloves, a flashlight, tissues, a cell phone, and other accessories.

### SUMMARY OF THE INVENTION

The present invention relates to breathable carrying bag for holding an animal waste bag. The carrying bag is made of material that allows the smell of the waste to be released to the environment. The carrying bag has an opening for placing the animal waste bag. The carrying bag has an attachment device to attach the carrying bag to a leash, collar, belt or other object. In this way, the carrying bag is a hands free device.

It is an object of the present invention to be able walk a dog without holding the waste bag in your hands, to be hands free.

It is an object of the present invention for the carrying bag to be attachable to the leash or collar of the dog.

It is an object of the present invention for the carrying bag to be attachable to a belt or purse of a user.

It is an object of the present invention for the carrying bag to hide or camouflage the bag carrying the animal waste.

It is an object of the present invention for the carrying bag to be made of different sizes.

It is an object of the present invention for the carrying bag to have a device for closing the bag.

It is an object of the present invention for the device for closing the bag to be strings that can be pulled or tied closed.

It is an object of the present invention for the bag to be made partially or totally of a mesh material.

It is an object of the present invention for the bag to be opaque towards the bottom of the carrying bag on one or both sides of the bag so that the waste bag cannot be seen in the bag.

It is an object of the present invention for the carrying device to have a pocket or multiple pockets for carrying items.

It is an object of the present invention for the pocket to carrying bags for placing the waste in.

It is an object of the present invention to have a device for closing the pocket. It is an object for that device to be snap, or hook device for closing the pocket and securing the contents in the pocket.

It is an object of the present invention for the carrying bag to have personalized items put on the bag.

It is an object of the present invention for the carrying bag to have a reflective material on it so that at night it can be seen.

It is an object of the present invention for the carrying bag to allow odors to escape to the environment and not be left with the carrying bag.

It is an object of the present invention for the carrying bag to be reusable after animal waste product bag is placed in it.

It is an object of the present invention for the carrying bag to be washable. It is an object of the present invention for a user to be able to customize the bag. It is an object of the present invention for the opaque section to me made of a material wherein rhinestones or other fashionable materials are placed on the opaque material.

When a user walks their dog, they usually bring a plastic bag to put the animal waste in. The user then has to spend the rest of the time holding the bag with the animal waste in their hand and the other hand on the leash of the dog. Therefore the user cannot perform any other tasks while walking the dog, plus they are holding the animal waste directly in their hands.

The present invention provides the user a carrying bag to put the animal waste in so that the user is not carrying the animal waste directly in their hands. The bag is an open bag that releases the odors to the environment, and can be reused. In an embodiment, the carrying bag is attached to the leash of the dog, a person's belt or another object where the user now has a hand available to perform other tasks. Further, the bag has an opaque section so that others do not have to see the animal waste bag. The animal waste bags are stored in a pocket of the carrying bag, so when a user is ready to remove the waste he takes a bag from a secure pocket of the carrying bag, places the waste in the animal waste bag and then places the animal waste bag in the carrying bag.

### BRIEF DESCRIPTION OF THE FIGURES

FIG. 1 shows a front view of an embodiment of the carrying bag of the present invention.

FIG. 2 shows a front view of an embodiment of the carrying bag of the present invention.

FIG. 3 shows a front view of an embodiment of the carrying bag of the present invention.

FIG. 4 shows a front view of an embodiment of the carrying bag of the present invention.

FIG. 5 shows a rear view of an embodiment of the carrying bag of the present invention.

### DETAILED DESCRIPTION OF THE INVENTION

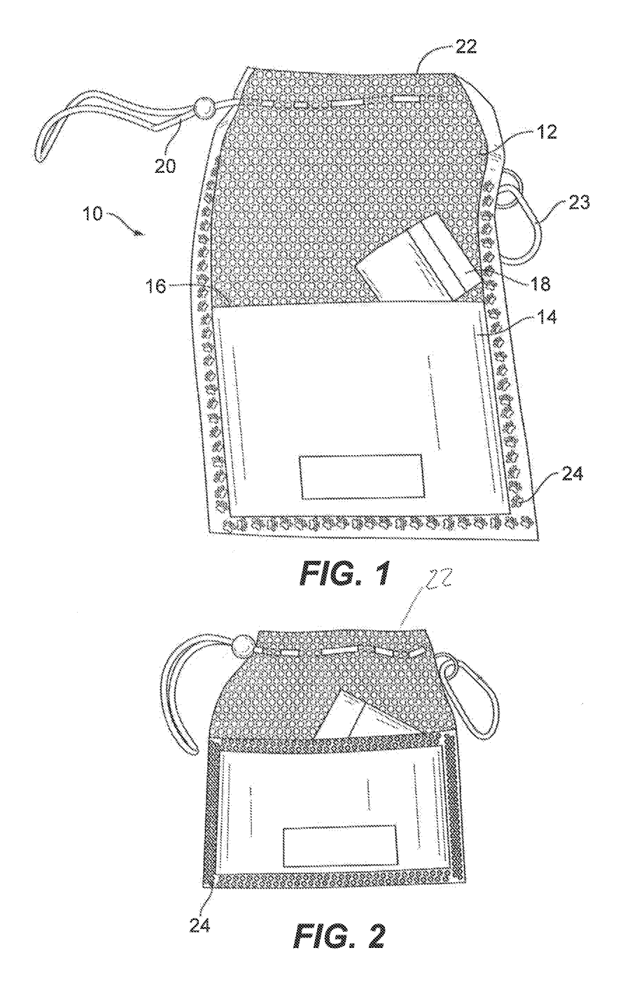

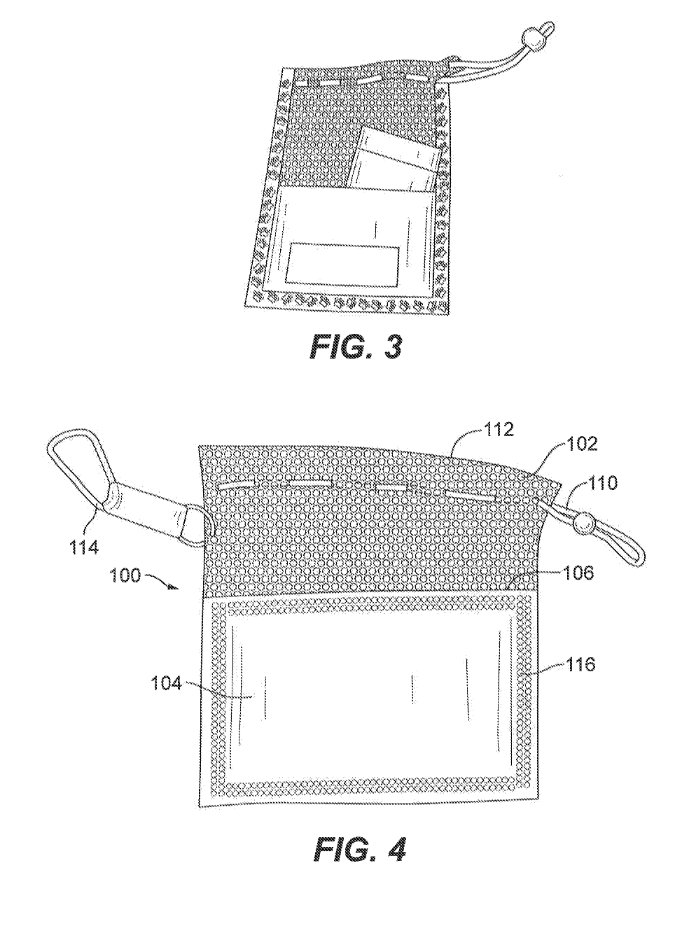

FIGS. 1-3 shows a front view of the carrying bag 10 of the present invention. FIG. 1 is a larger size version of the carrying bag than what is shown in FIGS. 2 and 3. The carrying bag 10 has an upper part 12 made of a breathable material such as mesh. The carrying bag 10 has a lower part 14 made of an opaque material. The carrying bag 10 has at least one pocket 16 for carrying items including animal waste bags 18. The carrying bag 10 has a closing mechanism 20 which is shown as a draw string in the figures. The carrying bag has an opening 22. The carrying bag has an attachment device 23 that can be attached to a dog's leash or be used to attach keys or other items to it. The carrying bag 10 also can have designs 24 printed or placed on the carrying bag.

FIG. 4 shows a front view of the carrying bag 100. The carrying bag 100 has an upper part 102 that is made of a breathable material such as mesh. The carrying bag has a lower part 104 that is made of an opaque material. The carrying bag 100 has at least one pocket 106 for carting items including animal waste bags 108 (not shown). The carrying bag 100 has a closing mechanism 110 which is shown as draw strings in the figures. The carrying bag 100 has an opening 112 which when open receives the animal waste bag. The carrying bag has an attachment device 114 that can be attached to a dog's leash or be used to attach keys or other items to it. The carrying bag 100 also can have designs 126 printed or placed on the carrying bag 100.

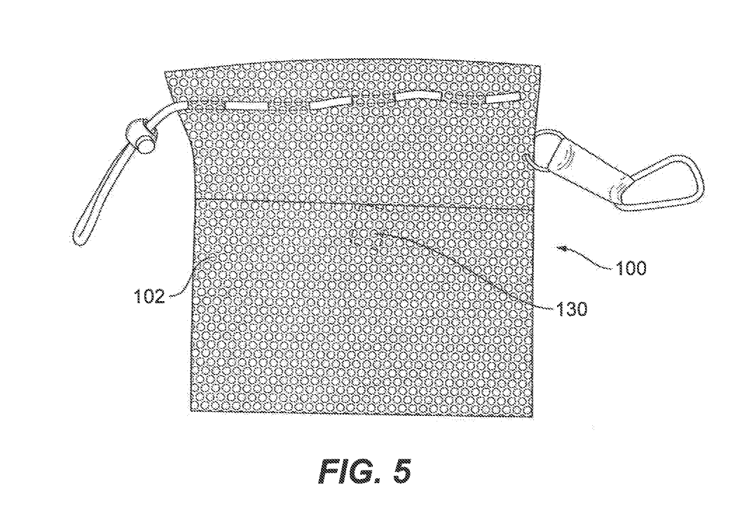

FIG. 5 shows the rear view of the carrying bag 100 shown in FIG. 4. The rear view shows the breathable material 102 being the entire length of the carrying bag 100 in the rear. The carrying bag 100 also has a closure mechanism 130 for closing the pocket 106.

1. A breathable carrying bag for holding an animal waste bag comprising:
a carrying bag made of material that allows smell of said waste to be released to environment;
an opening in said carrying bag to place said waste;
an attachment device to attach said carrying bag to a leash, collar, belt or other object.

2. The carrying bag of claim 1 further comprising at least one pocket.

3. The carrying bag of claim 1 further comprising an opaque section for covering said waste when it is placed in said carrying bag.

4. The carrying bag of claim 1 wherein a user is able walk a dog without holding said waste bag in said user's hands, and be hands free.

5. The carrying bag of claim 1 wherein said carrying bag hides or camouflages said animal waste bag.

6. The carrying bag of claim 1 wherein said carrying bag is made of different sizes.

7. The carrying bag of claim 1 further comprising a closing device for closing said carrying bag.

8. The carrying bag of claim 7 wherein said closing device comprises strings that are pulled or tied closed.

9. The carrying bag of claim 1 wherein said carrying bag is made partially or totally of a mesh material.

10. The carrying bag of claim 3 wherein said opaque section only covers a bottom of said carrying bag so that said animal waste bag cannot be seen in said carrying bag.

11. The carrying bag of claim 3 wherein said opaque section only covers a bottom front section of said carrying bag so that said animal waste bag cannot be seen in said carrying bag.

12. The carrying bag of claim 2 wherein said at least one pocket contains animal waste bags for placing the animal waste in.

13. The carrying bag of claim 1 further comprising a section for placing personal items and personal information on said carrying bag.

14. The carrying bag of claim 1 wherein said bag comprises a reflective material.

15. The carrying bag of claim 1 wherein said carrying bag is reusable after animal waste product bag is placed in it.

16. The carrying bag of claim 1 wherein said carrying bag is washable.

17. The carrying bag of claim 2 further comprising a closure mechanism for said pocket.
